(19) United States
(12) Patent Application Publication
(10) Pub. No.: US 2010/0079591 A1
(43) Pub. Date: Apr. 1, 2010

(54) WINDOW OF INFRARED SURVEILLANCE CAMERA

(75) Inventor: Han Mo LEE, Seoul (KR)

Correspondence Address: LRK Patent Law Firm, 1952 Gallows Rd, Suite 200, Vienna, VA, 22182, US

(73) Assignee: APRO MEDIA CO., LTD, Bucheon-si (KR)

(21) Appl. No.: 12/418,154

(22) Filed: Apr. 3, 2009

(30) Foreign Application Priority Data
Sep. 10, 2008 (KR) 10-2008-0089211

(51) Int. Cl. H04N 7/18; H04N 5/33

(52) U.S. Cl. 348/143; 348/164; 348/E05.09; 348/E07.085

(57) ABSTRACT

Disclosed therein is a window of an infrared surveillance camera, which can prevent that the window gets damp even though there is a difference in temperature between the inside and the outside of the surveillance camera due to a long time operation of the surveillance camera. The window includes: an illumination window mounted on a light path in front of an IR LED arranged around a camera module; a first lens window formed separately from the illumination window and mounted on an image introducing path in front of a lens of the camera module; an intercepting member having an assembly face where the illumination window and the first lens window are airtightly and closely combined with each other, the intercepting member being mounted between the illumination window and the first lens window for preventing that infrared rays are introduced from a light irradiation zone, where the IR LED is mounted, to a photograph zone, where the camera module is mounted; a combining ring assembled in front of the intercepting member for simultaneously restricting the illumination window and the first lens window; and a second lens window assembled to the combining ring and spaced apart from the first lens window through the combining ring so that a sealed air layer is formed between the second lens window and the first lens window.

### BACKGROUND OF THE INVENTION

1. Field of the Invention

The present invention relates to a window of an infrared surveillance camera, and more particularly, to a window of an infrared surveillance camera, which can prevent that the window gets damp due to a difference in temperature between the inside and the outside of the surveillance camera during an operation of the surveillance camera.

2. Background Art

In general, a surveillance camera is a photographing device, which takes a photograph of a specific place or thing, which is at a long distance and sends a captured image to a CCTV (Closed Circuit Television), so that a user can check conditions of the captured place or thing without going to the captured scene. The surveillance camera is generally installed at a specific place with a specific purpose, namely, in order to monitor the place where burglaries or accidents may occur or to check an operational state or a process flow of a machine.

The surveillance camera separately includes illuminating means to get images even in a place as dark as people cannot see things at night or since there is no or little illumination. As the illuminating means, there is an IR LED (Infrared Light Emitting Diode), and a surveillance camera, which has the IR LED, is called an infrared surveillance camera. The infrared surveillance camera can more effectively carry out monitoring since it adopts light, which people cannot see with eyes, as illumination.

As shown in FIG. 1, a generally-known conventional infrared surveillance camera includes: a camera module 100 for obtaining an image; an IR LED 110 for irradiating infrared lights to a photograph object; a housing 120 having an open front to receive and protect the camera module 100 and the IR LED 110; and a window 130 made of a transparent material and mounted at an open end of the housing 120 for protecting the camera module 100 and the IR LED 110 from the outside.

The window 130 includes an illuminating portion 132 mounted on a light-emit ting path of an LED illumination, a lens portion 134 mounted on a light-introducing path of a lens of the camera module 100, and intercepting members 136a and 136b mounted between the illuminating portion 132 and the lens portion 134 to join the illuminating portion 132 and the lens portion 134 with each other in such a way as to provide a partition for intercepting lights between the illuminating portion 132 and the lens portion 134, whereby the window 130 is constructed of a single window structure.

As described above, the conventional infrared surveillance camera adopts the window of the single window structure in order to protect the camera module and the IR LED from the outside and obtain the image. However, in case of the window of the single window structure, when there occurs difference in temperature between the outside and inside of the camera due to heating of devices by a long time operation, inner faces of the illuminating portion 132 and the lens portion 134 get damp. Particularly, since moisture formed on the inner face of the lens portion 134 noticeably deteriorates a quality of the image obtained from the camera module 100, the surveillance camera cannot occasionally show the function as the surveillance camera till moisture is removed.

### SUMMARY OF THE INVENTION

Accordingly, the present invention has been made to solve the above-mentioned problems occurring in the prior arts, and it is an object of the present invention to provide a window of an infrared surveillance camera, which can prevent that the window gets damp due to a difference in temperature between the inside and the outside of the surveillance camera during an operation of the surveillance camera.

To accomplish the above object, according to the present invention, there is provided a window of an infrared surveillance camera comprising: member being mounted between the illumination window and the first lens window for preventing that infrared rays are introduced from a light irradiation zone, where the IR LED is mounted, to a photograph tone, where the camera module is mounted; a combining ring assembled in front of the intercepting member for simultaneously restricting the illumination window and the first lens window; and a second lens window assembled to the combining ring and spaced apart from the first lens window through the combining ring so that a sealed air layer is formed between the second lens window and the first lens window.

Furthermore, the illumination window, the first lens window and the second lens window are made of a light-transmissible transparent material, and the intercepting member is made of light-interceptable opaque material.

Moreover, the intercepting member includes: an outer retaining jaw, to which an inner end portion of the illumination window is joined, and an inner retaining jaw, to which an outer end portion of the first lens window is joined; and an assembly end protrudingly extending between the outer retaining jaw and the inner retaining jaw, the assembly end being assembled with the combining ring.

In this instance, it is preferable that the assembly end has an axial length larger than thicknesses of the illumination window and the first lens window, so that the assembly end can protrude to rear faces of the illumination window and the first lens window through a gap between the illumination window and the first lens window when the window is assembled.

Furthermore, the combining ring includes: a concave coupling portion engagingly combined to the assembly end 344 in a male and female assembly form; a first retaining jaw formed integrally with an outer end of the coupling portion and a second retaining jaw formed integrally with an inner end of the coupling portion, which are respectively opposite to the outer retaining jaw and the inner retaining jaw of the intercepting member, the first and second retaining jaws respectively pressing and restricting the inner end portion of the illumination window and the cuter end portion of the first lens window and respectively positioned on the cuter retaining jaw and the inner retaining jaw; and a combining rim formed integrally with one side of the coupling portion, the combining rim having a combining face, to which the second lens window can be combined.

Preferably, the illumination window, the first lens window, the combining ring, and the second lens window are mutually bonded through ultrasonic melting, whereby the window according to the present invention can provide excellent watertightness and airtightness.

According to the present invention having the above structure, the second lens window is assembled in front of the first lens window through the combining ring in such a way as to be spaced apart from the first lens window, which as mounted in front of the camera module, at a predetermined interval, whereby the sealed air layer, which is the insulating layer, is formed between the first lens window and the second lens window. Accordingly, even though there is the difference in temperature between the inside and the outside of the surveillance camera due to heating of the devices by the long time operation of the surveillance camera, the inner face of the first lens window does not get damp due to a dew condensation.

Finally, since the window of the infrared surveillance camera according to the present invention has a double lens window structure mounted in front of the camera module and provides an insulating function owing to the sealed air layer formed between the first and second lens windows, it does not get damp even though there is the difference in temperature between the inside and the outside of the surveillance camera due to heating of the devices, whereby the present invention can continuously provide images of uniform quality.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view showing a structure of a conventional infrared surveillance camera;

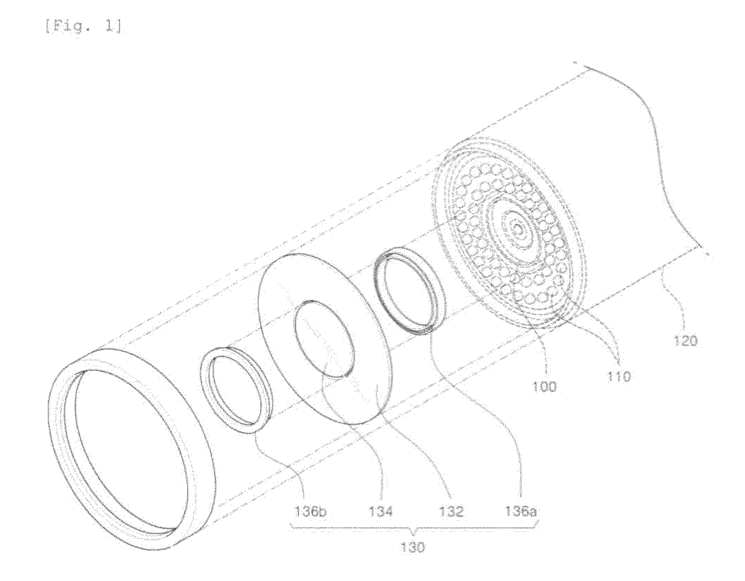

FIG. 2 is an exploded perspective view of a window of an infrared surveillance camera according to the present invention;

FIG. 3 is a sectional view showing a combined stats of the window of FIG. 2; and

FIG. 4 is a perspective view, in section, of a combining ring shown in FIGS. 2 and 3.

### DETAILED DESCRIPTION OF THE PREFERRED EMBODIMENT

Reference will be now made in detail to the preferred embodiment of the present invention with reference to the attached drawings.

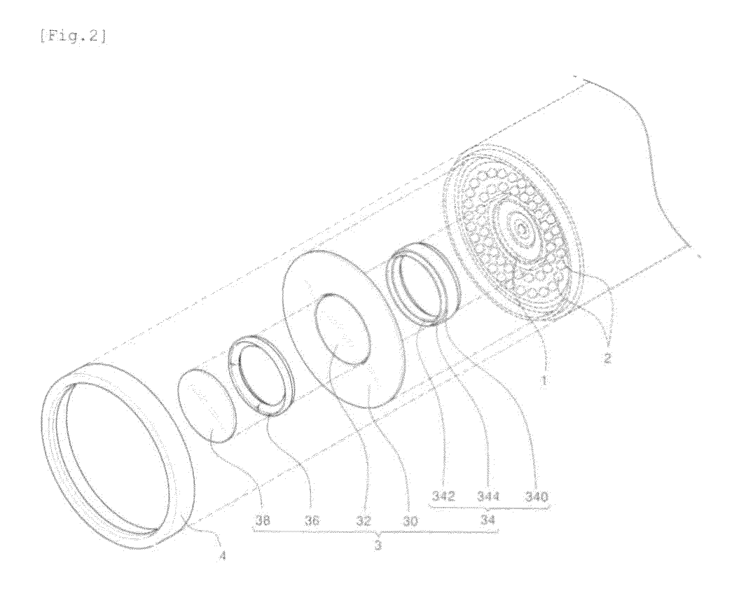

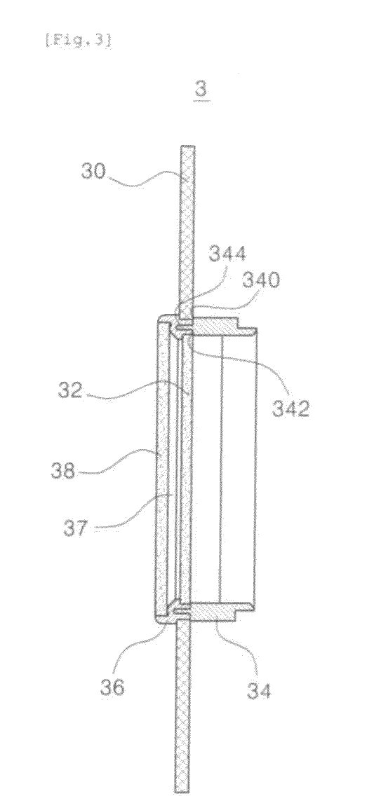

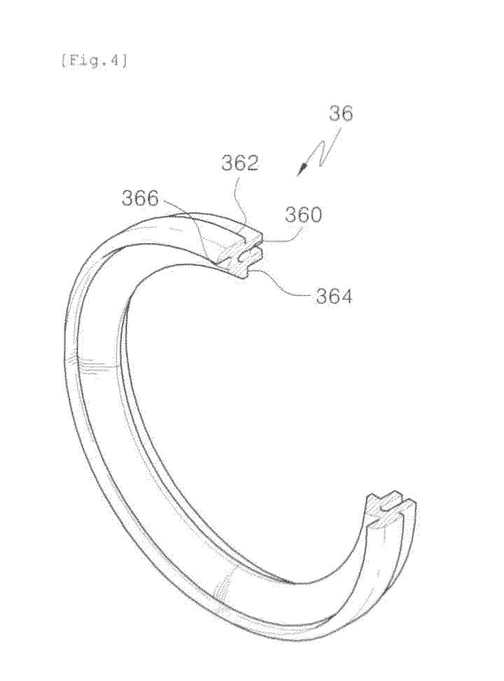

FIG. 2 is an exploded perspective view of a window of an infrared surveillance camera according to the present invention, FIG. 3 is a sectional view showing a combined state of the window of FIG. 2, and FIG. 4 is a perspective view, in section, of a combining ring shown in FIGS. 2 and 3.

As shown in the drawings, a window 3 of an infrared surveillance camera according to the present invention includes an illumination window 30, a first lens window 32, an intercepting member 34, a combining ring 36, and a second lens window 38. The second lens window 38 is assembled in front of the first lens window 32 through the combining ring 36 in such a way as to be spaced apart from the first lens window 32 at a predetermined interval, so that a sealed air layer 37, which is an insulating space, is formed between the first lens window 32 end the second lens window 38. The structure of window of the surveillance camera according to the present invention will be described in more detail.

The illumination window 30 is mounted on a light path in front of an IR LED 2 (Infrared Light Emitting Diode) arranged around a camera module 1, and the first lens window 32 is mounted on an image introducing path in front of a lens of the camera module 1. The illumination window 30 and the first lens window 32 are mutually combined in a state where the intercepting member 34 having an assembly face to allow an airtight assembly between the illumination window 30 and the first lens window 32 is interposed between the illumination window 30 and the first lens window 32. The intercepting member 34, which is mounted between the illumination window 30 and the first lens window 32, serves as a partition to prevent that infrared rays are introduced from a light irradiation zone, where the IR LED 2 is mounted, to a photograph zone, where the camera module 1 is mounted.

The illumination window 30, the first lens window 32, and the second lens window 33 are made of a light-transmissible transparent material, for instance, glass or transparent plastic. Since the intercepting member 34 has to serve to prevent that infrared rays are introduced from a light irradiation zone, where the IR LED 2 is mounted, to a photograph zone, where the camera module 1 is mounted, it is preferable that the intercepting member 34 is made of a light-interceptable material, for instance, opaque plastic or hard rubber.

The intercepting member 34 includes: an outer retaining jaw 340 formed on a combined end thereof, which is combined to the illumination window 30, in such a way that an inner end portion of a front face of the illumination window 30 of a flat form is closely combined to the outer retaining jaw 340; and an inner retaining jaw 342 formed on another combined end thereof, which is combined to the first lens window 32, in such a way that an outer end portion of a front face of the first lens window 32 of a flat form is closely combined to the inner retaining jaw 340. Accordingly, the illumination window 30 and the first lens window 32 can be airtightly combined to each other in a state where the inner end portion of the illumination window 32 and the outer end portion of the first lens window 32 are combined to the outer retaining jaw 340 and the inner retaining jaw 342.

An assembly end 344 protrudingly extends between the outer retaining jaw 340 and the inner retaining jaw 342 to a predetermined length. The assembly end 344 passes between the illumination window 30 and the first lens window 32 and partly protrudes to rear faces of the illumination window 30 and the first lens window 32 when the window is assembled. The combining ring 36 is joined to the assembly end 344 protruding to the rear faces of the illumination window 30 and the first lens window 32. The combining ring 36 simultaneously restricts the illumination window 30 and the first lens window 32 in a state where the inner end portion of the illumination window 30 and the outer end portion of the first lens window 32 are in close contact with each other, so that the illumination window 30 and the first lens window 32 are not separated to the outside.

Here, since the assembly end 344 must protrude to the rear faces of the illumination window 30 and the first lens window 32 through a gap between the illumination window 30 and the first lens window 32 when the window is assembled, the assembly end 344 must have an axial length larger than thicknesses of the illumination window 30 and the first lens window 32.

If the intercepting member 34 is made of a plastic material, it can be firmly joined to the illumination window 30 and the first lens window 32 through a ultrasonic melting method to heat, soften, melt and closely bond the plastic material by applying a ultrasonic vibration to the joined face thereof joined to the illumination window 30 and the first lens window 32.

When the illumination window 30, the first lens window 32, and the intercepting member 34 are bonded with one another through the ultrasonic melting method, the bonded portion of the intercepting member 34 is not easily transformed or damaged even through the illumination window 30 and the first lens window 32 are made of fragile glass. Furthermore, due to a strong bonding force, the window according to the present invention can provide excellent watertightness and airtightness and enhance productivity without needing an additional mediation member to combine the illumination window 30 and the first lens window 32 with each other. Moreover, the window according to the present invention can enhance its quality more since the entire of the bonded portion has a uniform bonding quality, and reduce a manufacturing cost.

The combining ring 36 includes a concave coupling portion 360, which is engagingly combined to the assembly end 344 in a male and female assembly form, and the coupling portion 360 includes a first retaining jaw 362 formed integrally with an cuter end thereof and a second retaining jaw 364 formed integrally with an inner end thereof.

The first and second retaining jaws 362 and 364, which are respectively opposite to the outer retaining jaw 340 and the inner retaining jaw 342 of the intercepting member 34, respectively press and restrict the inner end portion of the illumination window 30 and the outer end portion of the first lens window 32, respectively positioned on the outer retaining jaw 340 and the inner retaining jaw 342. The coupling portion 360 includes a combining rim 366 formed integrally with one side thereof, and the combining rim 366 has a combining face, to which the second lens window 33 can be combined.

As shown in FIG. 4, the second lens window 38 can be combined to the combining rim 366 in such a way that the second lens window 38 and the combining rim 366 are airtightly bonded with each other in a state where one side rim of the second lens window 38 is seated on a stepped jaw 368 formed between the combining rim 366 and the coupling portion 360. Also in this instance, if the combining ring 36 is made of the plastic material, it can be firmly joined to the second lens window 38 through the ultrasonic bonding method to heat, soften, melt and closely bond the plastic material by applying the ultrasonic vibration to the combined face thereof conjoined to the second lens window 38.

In the drawings, the unexplained reference numeral 4 designates a coupling ring for combining the window to the front open end of the housing of the infrared surveillance camera.

The conventional surveillance camera adopts the window of the single window structure. In this case, when there occurs a difference in temperature between the inside and the outside of the surveillance camera due to heating of devices by a long time operation of the surveillance camera, the inner faces of the illumination window and the lens window get damp. Particularly, since moisture formed on the inner face of the lens window becomes a cause to noticeably deteriorate the quality of an image obtained from the camera module, according to circumstances, the surveillance camera cannot show its function till the moisture is removed.

In the window of the surveillance camera according to the present invention, the second lens window 38 is assembled in front of the first lens window 32 through the combining ring 36 in such a way as to be spaced apart from the first lens window 32, which is mounted in front of the camera module, at the predetermined interval, whereby the sealed air layer 37, which is the insulating layer, is formed between the first lens window 32 and the second lens window 38. Accordingly, even though there is the difference in temperature between the inside and the outside of the surveillance camera due to heating of the devices by the long time operation of the surveillance camera, the inner face of the first lens window 32 does not get damp due to a dew condensation.

That is, since the window of the infrared surveillance camera according to the present invention has a double lens window structure mounted in front of the camera module and provides an insulating function owing to the sealed air layer formed between the first and second lens windows, it does not get damp even though there is the difference in temperature between the inside and the outside of the surveillance camera due to heating of the devices, whereby the present invention can continuously provide images of uniform quality.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A window of an infrared surveillance camera comprising:
an illumination window mounted on a light path in front of an IR LED (Infrared Light Emitting Diode) arranged around a camera module;
a first lens window formed separately from the illumination window and mounted on an image introducing each in front of a lens of the camera module;
an intercepting member having an assembly face where the illumination window and the first lens window are airtightly and closely combined with each other, the intercepting member being mounted between the illumination window and the first lens window for preventing that infrared rays are introduced from a light irradiation zone, where the IR LED is mounted, to a photograph zone, where the camera module is mounted;
a combining ring assembled in front of the intercepting member for simultaneously restricting the illumination window and the first lens window; and
a second lens window assembled to the combining ring and spaced apart from the first lens window through the combining ring so that a sealed air layer is formed between the second lens window and the first lens window.

2. The window of the infrared surveillance camera according to claim 1, wherein the illumination window, the first lens window and the second lens window are made of a light-transmissible transparent material, and the intercepting member is made of light-interceptable opaque material.

3. The window of the infrared surveillance camera according to claim 1, wherein the intercepting member includes:
an outer retaining jaw, to which an inner end portion of the illumination window is joined, and an inner retaining jaw, to which an outer end portion of the first lens window is joined; and
an assembly end protrudingly extending between the outer retaining jaw and the inner retaining jaw, the assembly end being assembled with the combining ring.

4. The window of the infrared surveillance camera according to claim 3, wherein the assembly end has an axial length larger than thicknesses of the illumination window and the first lens window.

5. The window of the infrared surveillance camera according to claim 3, wherein the combining ring includes:
a concave coupling portion engagingly combined to the assembly end 344 in a male and female assembly form;
a first retaining jaw formed integrally with an outer end of the coupling portion and a second retaining jaw formed integrally with an inner end of the coupling portion, which ate respectively opposite to the outer retaining jaw and the inner retaining jaw of the intercepting member, the first and second retaining jaws respectively pressing and restricting the inner end portion of the illumination window and the outer end portion of the first lens window, respectively positioned on the outer retaining jaw and the inner retaining jaw; and
a combining rim formed integrally with one side of the coupling portion, the combining rim having a combining face, to which the second lens window can be combined.

6. The window of the infrared surveillance camera according to claim 1, wherein the illumination window, the first lens window, the combining ring, and the second lens window are mutually bonded through ultrasonic melting.
